(19) United States
(12) Patent Application Publication
(10) Pub. No.: US 2006/0175172 A1
(43) Pub. Date: Aug. 10, 2006

(54) Drive system for swivelling a panel of a vehicle

(75) Inventors: Timo Frieb-Preis, Munstermaifeld (DE); Michael Kleinmann, Melsbach (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH

(21) Appl. No.: 11/343,998

(22) Filed: Jan. 31, 2006

(30) Foreign Application Priority Data
Feb. 8, 2005 (DE) 10 2005 005 648.2

(51) Int. Cl. E05F 15/12

(52) U.S. Cl. 192/84.91

(57) ABSTRACT

A drive system for swiveling a panel of a vehicle about a swivel axis includes a reversible drive motor, a rotor which can be driven to rotate about an axis of rotation by the drive motor, and a coil through which current can flow to produce an axial magnetic field, the coil being arranged coaxially to the axis of rotation. An armature arranged to move axially with respect to the rotor and the coil can be moved axially into contact with the rotor to produce an interlocking connection or a friction connection between the rotor and the armature. A drive wheel is arranged to rotate with the armature via a drive train, the drive wheel being arranged to swivel the panel.

### BACKGROUND OF THE INVENTION

1. Field of the Invention

The invention relates to a drive for swivelling a panel which is arranged on the bodywork of a vehicle such that it can swivel about a swivel axis, having a reversible drive motor by means of which a drive wheel of a swivelling apparatus can be rotated via a drive train, by which swivelling apparatus the panel can be swivelled.

2. Description of the Related Art

According to a known drive system for swivelling a panel, a clutch is arranged in the drive train in order to interrupt the drive train, and a brake is arranged downstream from the clutch in the drive direction in order to brake that part of the drive train which is located downstream from the clutch.

In a drive such as this, an electric motor rotates a worm which, via a worm gear, drives an input shaft to a clutch. The output shaft from the clutch in turn uses a pinion to drive a gearwheel of a drive roll of a swivelling apparatus, by which the panel can be swivelled.

### SUMMARY OF THE INVENTION

One object of the invention is to provide a drive of the type mentioned initially which is of simple design and in which the panel is held in the respectively assumed position when no current is flowing.

According to the invention, this object is achieved by a rotor that can be driven by the drive motor such that it can rotate about a rotation axis, and a coil through which current can flow, which is arranged axially with respect to the rotation axis and can produce an axial magnetic field. An armature is arranged such that it can more axially with respect to the rotor and coil, can be influenced by the magnetic field and is connected to the drive wheel such that they rotate together. The armature can be moved into contact with the rotor by the magnetic field, producing an interlocking connection and/or a friction connection between the rotor and the armature.

This design allows the drive to be constructed in such a way that it requires few components and only a small physical space, and in which the panel is held in its respectively assumed position when no current is flowing through the coil.

Since current flows through the coil only while the panel is moving, the energy consumption is very low.

Furthermore, three drive states can be set in a simple manner, specifically motor movement, holding in the assumed position and manual movement.

The armature can be moved into contact with the rotor by the magnetic field against a force, thus allowing motor-driven movement of the panel by means of the drive motor.

If the force profile has a step rise in its central area and only about 50% of the current is flowing, then the panel can be moved freely by hand.

It is simple for the force to be the force of one or more springs, in particular of one or more compression springs.

In this case, the compression springs are cup springs, thus resulting in a small physical size.

However, it is also possible and, if the force profile has a step rise, it is advantageous, for the compression springs to be helical compression springs.

In order to achieve an axial design which requires only a small physical size, the armature is preferably a permanent-magnet armature which is magnetized axially.

In this case, the armature may comprise a mount composed of non-ferromagnetic material, into which the permanent magnets are inserted.

Furthermore, the rotor may be composed of a ferromagnetic material, and there may be an attraction force between the armature and the rotor.

In order to allow a simple design of small size with the capability to assume three positions at the same time, a stationary component composed of a ferromagnetic material may be arranged axially on that side of the armature which faces away from the rotor, against which stationary component the armature can be moved into contact, producing an interlocking connection and/or a friction connection between the stationary component and the armature, with there being an attraction force between the armature and the stationary component.

In order to allow free manual operation of the panel, a second force, which is in the opposite direction to but corresponds to the first force, can be applied to the armature, in which case it is simple for the second force to be the force of one or more springs, in particular of one or more compression springs, which may be cup springs or helical compression springs.

If the drive motor is an electric motor, then once again current flows through it only in order to move the panel, thus keeping the energy consumption small.

In order to allow the panel to be operated freely by hand, the drive motor may be a non-self-locking drive motor.

Exemplary embodiments of the invention will be described in more detail in the following text and are illustrated in the drawing.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a cross section through a first exemplary embodiment of a drive,

FIG. 2 shows a cross section through a second exemplary embodiment of a drive,

FIG. 3 shows a cross section through a third exemplary embodiment of a drive,

FIG. 4 shows a cross section through a fourth exemplary embodiment of a drive, and

FIG. 5 is a schematic view of the drive system.

### DETAILED DESCRIPTION OF THE PRESENTLY PREFERRED EMBODIMENTS

The drives illustrated in the figures have a rotor 2 which can be rotated about a rotation axis 1 by an electric motor M (FIG. 5) and has a clutch surface 3 which extends transversely with respect to the rotation axis 1.

An armature 4, 4′, 4″, 4″′ is arranged coaxially with respect to the rotation axis 1 and has a second clutch surface 5, opposite the first clutch surface 3.

The armature 4, 4′, 4″, 4″′ is arranged such that it can move axially and, on its side facing away from the rotor 2, has a drive shaft 6 by means of which a drive wheel W (FIG. 5) of a swivelling apparatus can be rotated. A panel (which is likewise not illustrated) can be swivelled by the swivelling apparatus.

Furthermore, an annular coil 7 is arranged coaxially with respect to the rotation axis 1 and produces an axial magnetic field (which can be used to move the armature 4, 4′, 4″, 4″′ axially) when current flows through it.

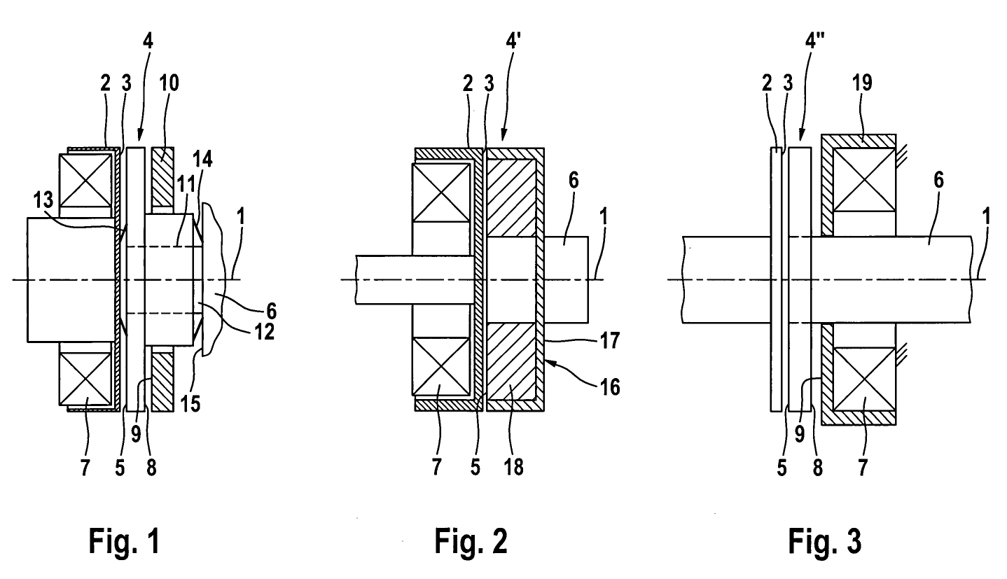

In the exemplary embodiment in FIG. 1, the disc-like armature 4 has on its side facing away from the rotor 2 a third clutch surface 8, which is opposite a stationary fourth clutch surface 9 and is at an axial distance from it, with the fourth clutch surface 9 being formed on an annular component 10 composed of a ferromagnetic material.

The armature 4 has a coaxial guide hole 11, by means of which it is seated on one end 12 of the drive shaft 6 such that they rotate together, but such that it can be moved axially.

The armature 4 is supported in a sprung manner via a first cup spring 13 axially on the rotor 2 and via a second cup spring 14 in a step 15 on the drive shaft 6.

The armature 4 is a permanent-magnetic armature 4, which is magnetized axially, such that there is an attraction force between it and the annular component 10.

The annular coil 7 is arranged on the side of the rotor 2 facing away from the armature 4.

When no current is flowing through the annular coil 7, the armature 4 is held in a mid-position by the cup springs 13 and 14, which act in opposite senses to one another and have approximately the same strength, in which mid-position the armature 4 is not in contact with either the rotor 2 or the component 10.

The panel can thus be swivelled manually, largely without any resistance.

When current flows through the annular coil in a first current direction, the second clutch surface 5 of the armature 4 is drawn by the magnetic field produced in this case into contact with the first clutch surface 3, thus producing a friction connection between these two clutch surfaces 3 and 5. This results in the production of a rotating connection from the electric motor to the drive shaft 6, so that the panel can be swivelled by the electric motor.

When current ceases to flow through the annular coil 7, the cup springs 13 and 14 move the armature 4 back to its mid-position, possibly assisted by a short current pulse applied to the annular coil in a second flow direction.

When current flows through the annular coil 7 in the second flow direction, the third clutch surface of the armature 4 is moved by the magnetic field that is produced during this process into contact with the fourth clutch surface 9 on the annular component 10, thus resulting in a friction connection between these two clutch surfaces 8 and 9, and this connection is maintained by the magnetic force of the permanent-magnet armature 4 even after the end of the current flow through the annular coil 7. In this case, the panel is held in the position assumed at that time without any need for current to flow through the annular coil 7.

A short current pulse in the first flow direction moves the armature 4 back to its mid-position.

In the exemplary embodiment shown in FIG. 2, the armature 4′ has a pot-like aluminum housing 16, on whose base 17 the drive shaft 6 is arranged. The opening in the aluminum housing 16 points towards the rotor 2. An axially magnetized permanent magnet 18 with an attraction force to the rotor is inserted into the aluminum housing 16. The annular coil 7 is arranged on the side of the rotor 2 facing away from the armature 4. When current flows in a first direction through the annular coil 7, the second clutch surface 5 of the armature 4′ is attracted by the magnetic field that is produced in this case to the first clutch surface 3 of the rotor 2, thus producing a friction connection between these two clutch surfaces 3 and 5.

A rotating connection is thus produced from the electric motor to the drive shaft 6, so that the panel can be swivelled by the electric motor.

When the current flow through the annular coil 7 in the first current direction ends, the friction connection between the first and the second clutch surfaces 3 and 5 is maintained by the magnetic force of the permanent magnet 18 in the armature 4′, so that the panel is held in the position that it has assumed, without any current flowing through the annular coil 7, by the self-locking of the electric motor.

If it is intended to move the panel manually, current is passed through the annular coil 7 in its second flow direction, so that the magnetic fields of the annular coil 7 and of the permanent magnet 18 repel one another. The armature 4′ is thus moved away from the rotor 2, and the panel can be swivelled manually.

In the exemplary embodiment shown in FIG. 3, the rotor 2 is composed of a non-ferromagnetic material. The annular coil 7 is arranged coaxially on the side of the disc-like armature 4″ facing away from the rotor 2.

The armature 4″ is a permanent-magnet armature 4″, which is magnetized axially and whose attraction force acts axially towards the annular coil 7, which is provided with a stationary ferromagnetic coil housing 19.

When no current is flowing through the annular coil 7, the third clutch surface 8 of the armature 4″, which faces the annular coil 7, is drawn by the magnetic force of the permanent magnet 18 into contact with the fourth clutch surface 9 (which faces it) on the coil housing 19, thus producing a friction connection between these two clutch surfaces 8 and 9.

The panel is thus held in the respectively assumed position, without any current flowing through the annular coil 7.

When the current flows through the annular coil 7 in a first direction, it produces a magnetic field which repels the armature 4″, so that the second clutch surface 5 of the armature 4″ is moved into contact with the first clutch surface 3 of the rotor 2, and produces a friction connection or interlocking connection between these two clutch surfaces 3 and 5.

A rotating connection is thus produced between the electric motor and the drive shaft 6, so that the panel can be swivelled by the electric motor.

If current flows through the annular coil 7 in a pulsed manner or with a relatively small current intensity in the first flow direction, although the armature 4″ is lifted off the coil housing 19 via the magnetic fields produced by the annular coil 7 in this case, it does not, however, come into contact with the rotor 2. The panel can thus be swivelled freely by hand.

When current flows through the annular coil 7 in a second flow direction, then the friction connection between the third and fourth clutch surfaces 8 and 9 is reinforced. However, it is sufficient for current to flow through the annular coil 7 only in the first flow direction.

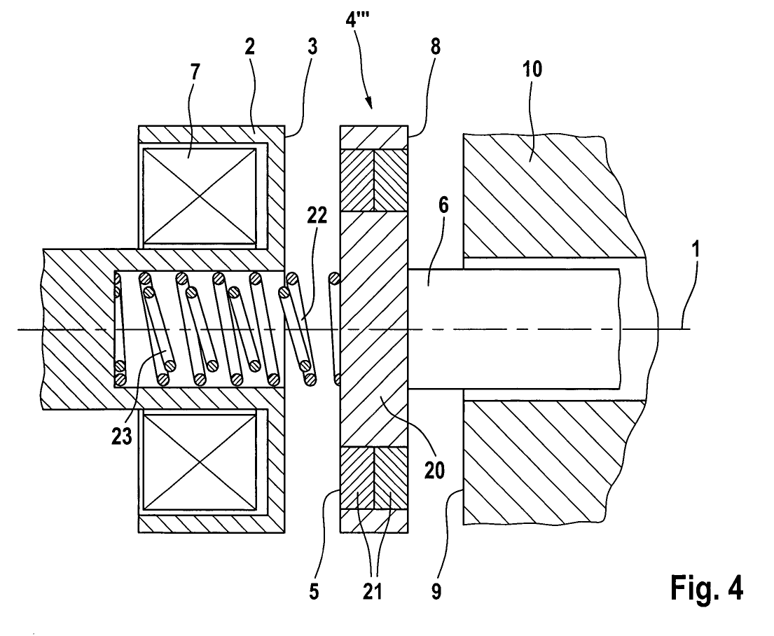

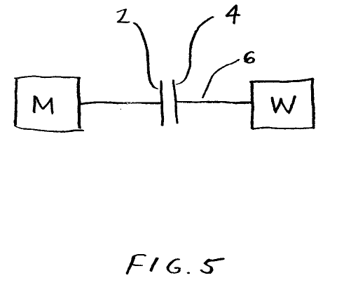

In the exemplary embodiment shown in FIG. 4, the armature 4″′ comprises a mount 20 composed of non-ferromagnetic material, into which axially magnetized permanent magnets 21 are inserted. The drive shaft 6 is arranged fixed on the mount 20.

The annular coil 7 is arranged on the side of the rotor 2 facing away from the armature 4″′.

A stationary annular component 10 composed of a ferromagnetic material is arranged coaxially on the side of the armature 4″′ facing away from the rotor 2, with an attraction force between it and the permanent magnets 21 in the armature 4″′.

Two coaxially arranged helical compression springs 22 and 23 of different diameters are supported on the rotor 2, of which the other end of the first helical compression spring 22, which has the greater length, makes contact with the armature 4″′.

When current flows through the annular coil 7 in a first flow direction, a magnetic field is produced which moves the armature 4″′ into contact with the rotor 2, with the helical compression springs 22 and 23 being compressed.

During this process, the clutch surface 5 on the armature 4″′ comes into contact with the first clutch surface 3 on the rotor 2, thus producing a friction connection between these two clutch surfaces 3 and 4.

This results in a rotating connection from the electric motor to the drive shaft 6, so that the electric motor can swivel the panel.

If current at a lower current level flows through the annular coil 7 in the first flow direction, the magnetic force of the annular coil 7 can overcome only the force of the first helical compression spring 22, but not the step rise in the profile of the overall force of the two helical compression springs 22 and 23 that is produced by the second helical compression spring 23.

The armature 4″′ is thus moved to a mid-position, in which the panel can be moved by hand.

When no current is flowing through the annular coil 7, the third clutch surface 8 of the armature 4″′ is moved into contact with a fourth clutch surface 9 on the annular component 10, possibly with the assistance of a short current pulse in the second flow direction, thus producing a friction connection between these two clutch surfaces 8 and 9.

The panel is thus held in the currently assumed position, without any current flowing through the annular coil 7.

FIG. 5 is a schematic view of the drive system showing the motor M which drives the rotor 2, and armature A which can be connected to rotor 2 in order to rotate drive wheel W, either by shaft 6 or an alternative drive train. The rotor 2 and armature 4 may be arranged as shown in any of FIGS. 1 to 4.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A drive system for swiveling a panel of a vehicle about a swivel axis, said system comprising:
a reversible drive motor;
a rotor which can be driven to rotate about an axis of rotation by the drive motor;
a coil through which current can flow to produce an axial magnetic field, said coil being arranged coaxially to said axis of rotation;
an armature arranged to move axially with respect to the rotor and the coil, the armature being connectable to the rotor by the magnetic field produced by the coil; and
a drive wheel which can be driven by the armature via a drive train, the drive wheel being arranged to swivel the panel.

2. The drive system of claim 1 further comprising means for producing a disconnect force, the armature being connectable to the rotor against the disconnect force.

3. The drive system of claim 2 wherein the disconnect force has force profile with a central area having a step rise.

4. The drive system of claim 2 wherein the means for producing the disconnect force comprises at least one compression spring.

5. The drive system of claim 4 wherein the at least one compression spring comprises cup springs.

6. The drive system of claim 4 wherein the at least one compression spring comprises helical springs.

7. The drive system of claim 1 wherein the armature comprises a permanent magnet which is axially magnetized.

8. The drive system of claim 7 wherein the armature comprises a non-ferromagnetic mount in which permanent magnets are inserted.

9. The drive system of claim 7 wherein the rotor comprises a ferromagnetic material which is attracted to the armature by a first force.

10. The drive system of claim 7 further comprising a stationary component arranged axially on a side of the armature facing away from the rotor, the armature being axially movable to connect to the stationary component, the stationary component being a ferromagnetic material which is attracted to the armature.

11. The drive system of claim 9 further comprising means for producing a second force which opposes the first force, the armature being connectable to the rotor against the second force.

12. The drive system of claim 11 wherein the means for producing the second force comprises at least one compression spring.

13. The driver system of claim 12 wherein the at least one compression spring comprises one of cup springs and helical springs.

14. The drive system of claim 1 wherein the drive motor is an electric motor.

15. The drive system of claim 1 wherein the drive motor is a non-self-locking motor.
